(19) United States
(12) Patent Application Publication
(10) Pub. No.: US 2014/0175112 A1
(43) Pub. Date: Jun. 26, 2014

(54) VENDING MACHINE WITH HEATING BOX

(71) Applicants: Hon Hai Precision Industry Co., Ltd., New Taipei (TW); Hong Fu Jin Precision Industry (WuHan) Co., Ltd., Wuhan (CN)

(72) Inventors: CHIN-WEN YEH, New Taipei (TW); ZHI-JIAN PENG, Wuhan (CN); DUN-JUN ZHOU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/972,867

(22) Filed: Aug. 21, 2013

(30) Foreign Application Priority Data
Dec. 20, 2012 (CN) 2012105575557

(51) Int. Cl. G07F 9/10

(52) U.S. Cl. CPC G07F 9/105
USPC 221/150 A

(57) ABSTRACT

A vending machine supplying heated goods includes a cabinet and an output delivering device mounted to the cabinet. The cabinet defines a product storing area, a receiving area, and a pickup opening communicating with the receiving area. The output delivering device includes a delivering strap and a heating box mounted to the delivering strap. The heating box receives and heats one of the plurality of products and the delivering strap is then driven to move to drive the heating box to move to a position in which the product drops out of the heating box into the receiving area for the customer to pick up.

### BACKGROUND

1. Technical Field

The present disclosure relates to vending machines, more particularly to a vending machine with a heating box.

2.Description of Related Art

Vending machines allow customers to buy product twenty fours a day. However, the vending machine cannot sell hot or heated products. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a vending machine in accordance with an embodiment.

FIG. 2 is an exploded, isometric view of the output delivering device of FIG. 1.

FIG. 3 is similar to FIG. 2, but viewed from another aspect.

FIG. 4 is an assembled view of the output delivering device of FIG. 2.

FIG. 5 is an assembled view of the output delivering device of FIG. 1.

FIG. 6 is another assembled view of the output delivering device of FIG. 1.

FIG. 7 is similar to FIG. 5, but viewed from another aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

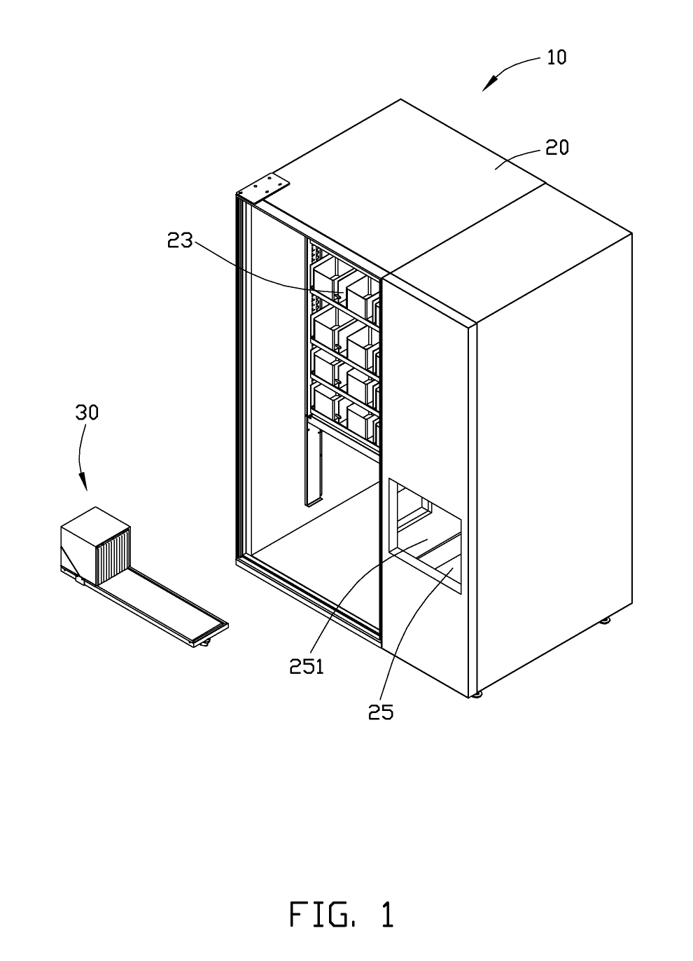

FIG. 1 illustrates a vending machine 10 in accordance with an embodiment. The vending machine 10 includes a cabinet 20. The cabinet 20 defines a storing area 23 for receiving the products. An output delivering device 30 is slidably mounted to the cabinet 20. The output delivering device 30 is located in front of the storing area 23. The cabinet 20 defines a pickup opening 25 and a receiving area 251 communicating with the pickup opening 25.

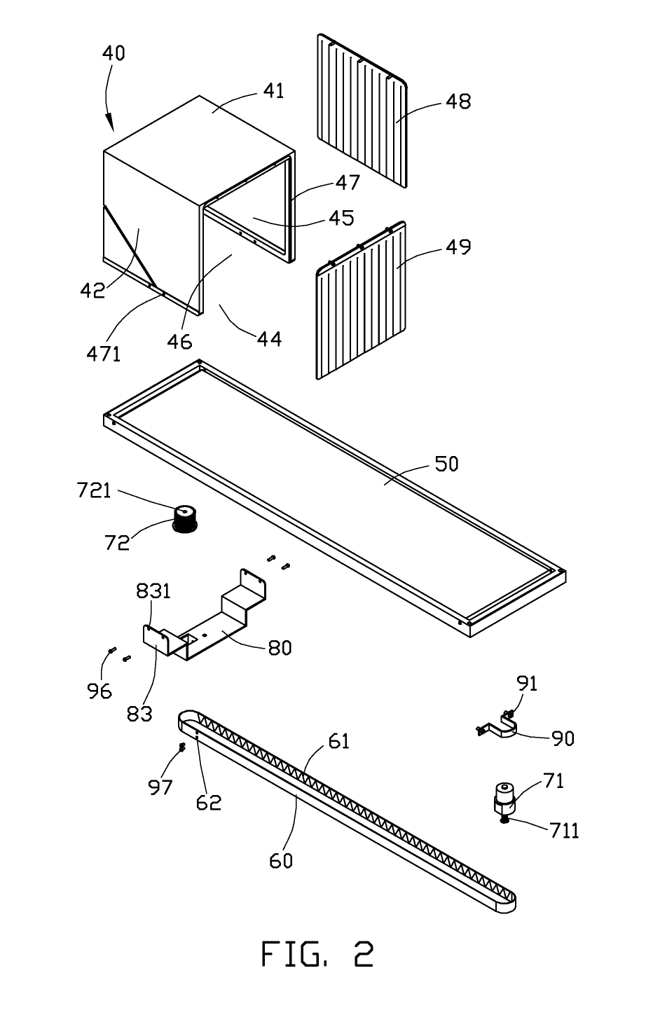

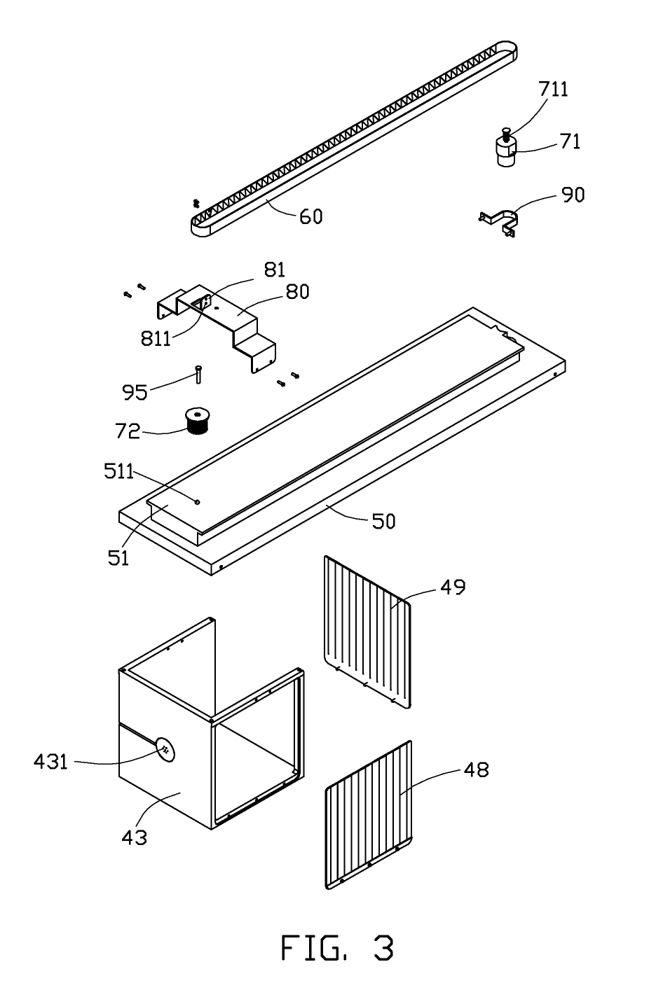

FIGS. 2 and 3 show that the output delivering device 30 includes a heating box 40, a mounting panel 50, a delivering strap 60, a motor 71, and a slave gear 72.

The heating box 40 is cube-shaped. The heating box 40 includes a top panel 41, a first side panel 42, a rear panel 43, and a second side panel 47. The first side panel 42 is substantially parallel to the second side panel 47 and is substantially perpendicular to the top panel 41. The rear panel 43 is connected between the first side panel 42 and the second side panel 47. The rear panel 43 is substantially perpendicular to the first side panel 42 and the top panel 41. The second side panel 47 defines an input opening 45. A first output opening 44 is surrounded by the rear panel 43, the first side panel 42, and the second side panel 47. A second output opening 46 is surrounded by the top panel 41, the first side panel 42, and the second side panel 47. A first soft shade 48 is mounted to the top panel 41 to cover the input opening 45. A second soft shade 49 is mounted to the top panel 41 to cover the second output opening 46. Each of the first side panel 42 and the second side panel 47 defines two first securing holes 471. The heat generating element 431 is attached to the rear panel 43.

The mounting panel 50 includes a protrusion 51, the protrusion 51 defines a first mounting hole 511. One side of the protrusion 51 defines two second mounting holes (not shown).

The motor 71 includes a drive gear 711. The delivering strap 60 is connected to the drive gear 711 and the slave gear 72. The delivering strap 60 defines engaging slots 61. The delivering strap 60 defines two first fastening holes 62. The slave gear 72 defines a pivot hole 721.

A mounting member 80 secures the heating box 40 to the mounting panel 50. The mounting member 80 includes a securing tab 81. The securing tab 81 defines two second fastening holes 811. The mounting member 80 includes two securing arms 83. Each securing arm 83 defines two second securing holes 831.

A securing member 90 secures the motor 71 to the mounting panel 50 and two screws 91 are secured to two ends of the securing member 90.

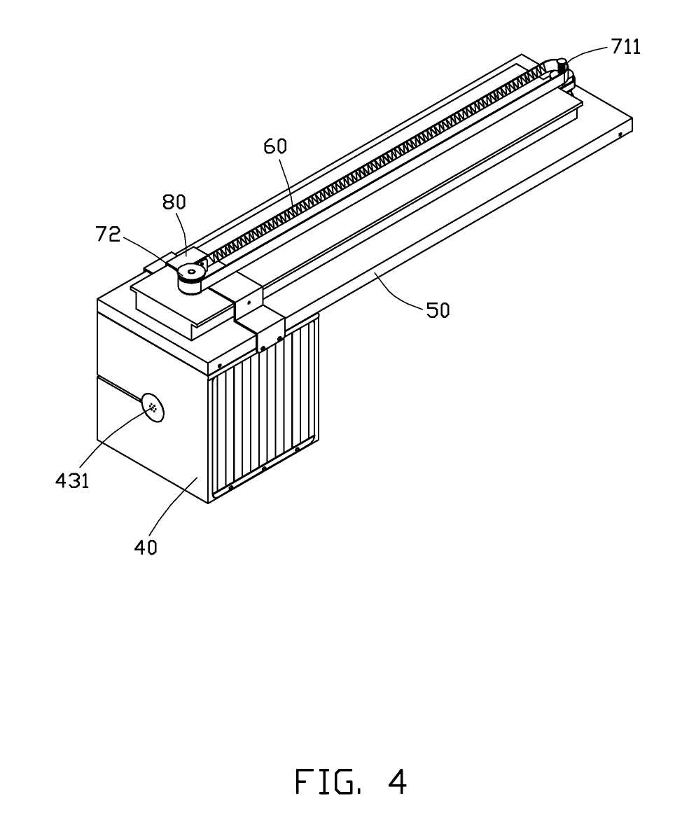

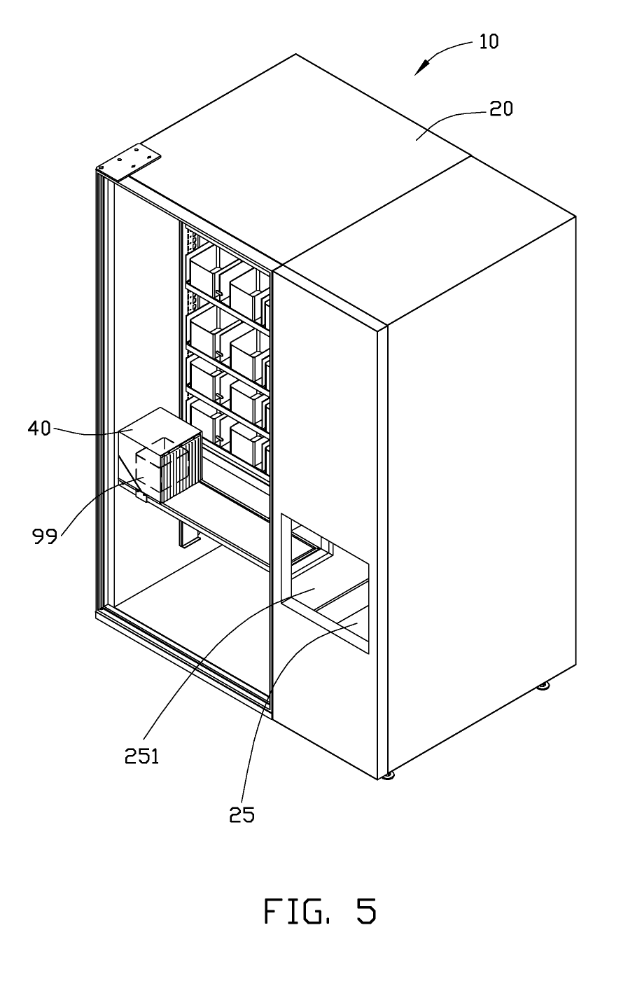

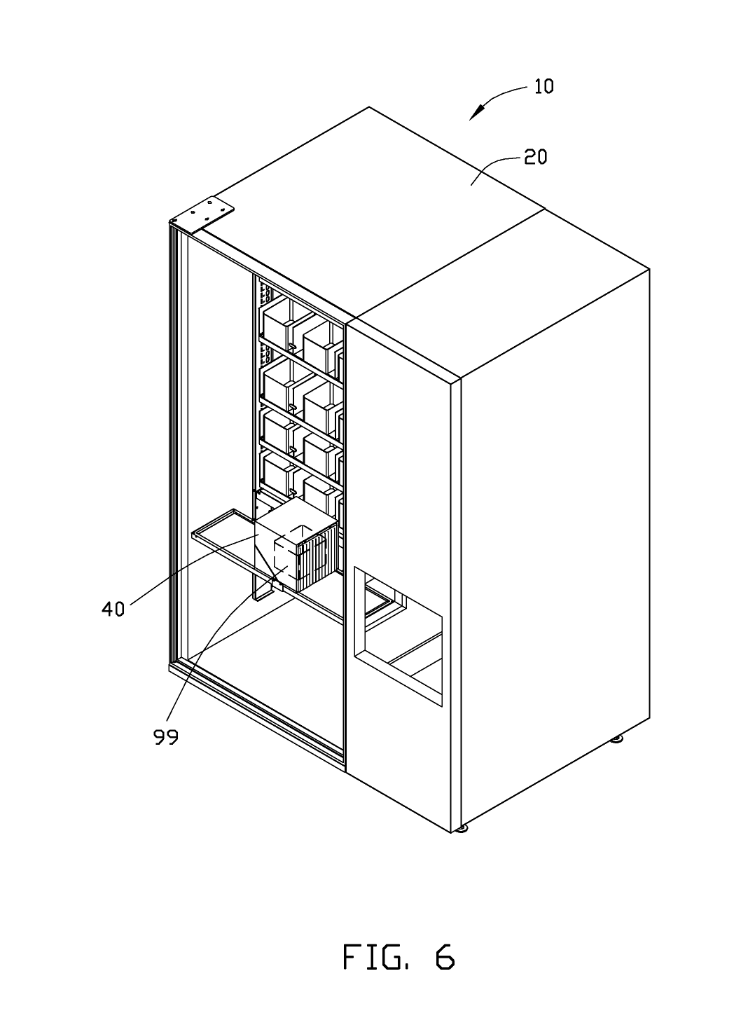

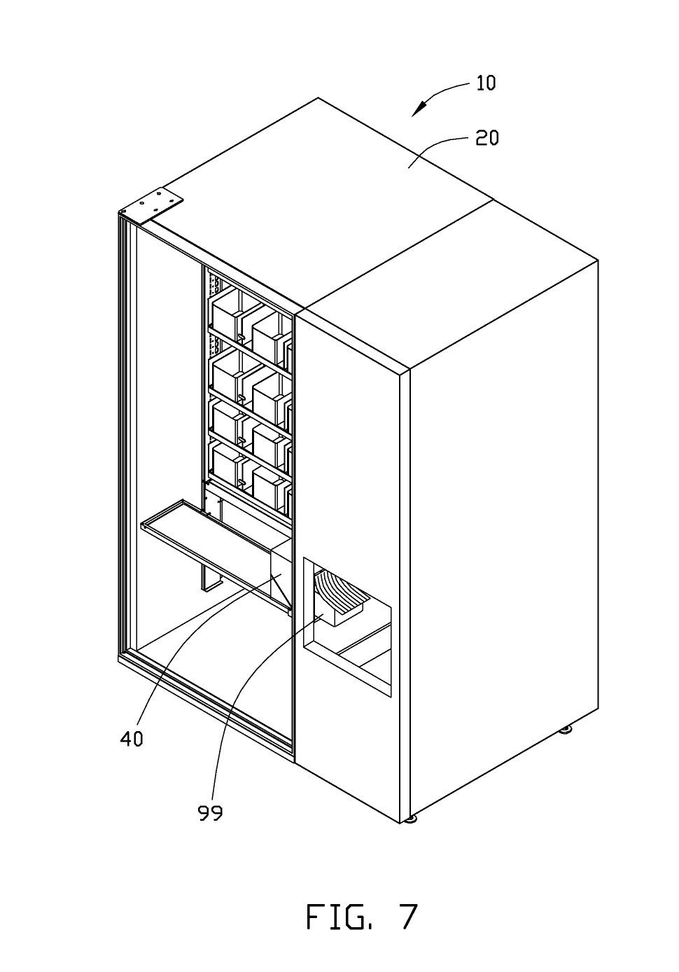

FIGS. 1 to 7 show that, in assembly, the securing member 90 surrounds the motor 71, and the screws 91 are secured into the second mounting holes of the protrusion 51, thereby securing the motor 71 to the mounting panel 50. The pivot hole 721 of the slave gear 72 is aligned with the first mounting hole 511, and a pivot shaft 95 passes through the pivot hole 721 and is secured in the first mounting hole 511, thereby securing the slave gear 72 to the lower side of the mounting panel 50. Then the delivering strap 60 is connected to the slave gear 72 and the drive gear 711 of the motor 71. The mounting member 80 is placed on the bottom portion of the mounting panel 50 to enable the second securing holes 831 of the securing arm 83 to be aligned with the first securing holes 471 of the heating box 40. A plurality of fasteners 96 are secured into the first securing holes 471 and the second securing holes 831 to secure the mounting member 80 to the heating box 40. The mounting member 80 prevents the heating box 40 from moving vertically along the mounting panel 50. The two second fastening holes 811 of the mounting member 80 are aligned with the two first fastening holes 62 of the delivering strap 60. Two fasteners 97 are secured into the second fastening holes 811 and the first fastening holes 62, thereby securing the mounting member 80 to the delivering strap 60. The first soft shade 48 is mounted to the top panel 41 to cover the input opening 45. Finally, the second soft shade 49 is mounted to the top panel 41 to cover the second output opening 46.

In use, a product 99 is pushed along a first direction into the heating box 40 via the input opening 45. The heat generating element 431 heats the product. The first soft shade 48 and the second soft shade 49 prevent hot air flowing out of the heating box 40. The drive gear 711 of the motor 71 rotates to drive the delivering strap 60 to rotate. The driving the heating box 40 and the product 99 are driven to move, along a second direction substantially perpendicular to the first direction, on the mounting panel 50, until the product 99 moves out of the mounting panel 50 and drops from the first output opening 44, or from the second output opening 46, to the receiving area 251. The product 99 can then be picked up via the pickup opening 25.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A vending machine comprising:
a cabinet, the cabinet defines a storing area for storing a plurality of products, a receiving area, and a pickup opening communicating with the receiving area; and
an output delivering device mounted to the cabinet, the output delivering device comprises a delivering strap and a heating box mounted to the delivering strap; the heating box defines an input opening and a first output opening; the heating box is configured to receive one of the plurality of products via the input opening and heat the one of the plurality of products;
wherein the delivering strap is driven to move to drive the heating box to move to a position, in which the one of the plurality of products drops out of the heating box to the receiving area via the first output opening; and the pickup opening is configured to allow the one of the plurality of products in the receiving area to be picked up.

2. The vending machine of claim 1, wherein the output delivering device further comprises a mounting panel, and the heating box is configured to move on the mounting panel.

3. The vending machine of claim 2, wherein the output delivering device further comprises a motor and a slave gear; the motor and the slave gear are mounted on the mounting panel; the motor comprises a drive gear; the delivering strap is connected to the slave gear and the drive gear; the motor is configured to drive the delivering strap to rotate, thereby driving the heating box to move relative to the mounting panel.

4. The vending machine of claim 3, wherein the output delivering device further comprises a mounting member; the mounting member is mounted to the delivering strap and the heating box; and the delivering strap and the heating box are located on opposite sides of the mounting panel.

5. The vending machine of claim 4, wherein the heating box defines two first securing holes; the mounting member comprises two securing arms; each of the two securing arms defines a second securing hole corresponding to the first securing hole.

6. The vending machine of claim 1, wherein the heating box comprises a top panel, a first side panel extending from the top panel, a second side panel extending from the top panel, and a rear panel connected between the first side panel and the second side panel; the input opening is defined in the first side panel; and the first output opening is surrounded by the first side panel, the second side panel, and the rear panel.

7. The vending machine of claim 6, wherein the heating box comprises a soft shade mounted to the top panel and covering the input opening.

8. The vending machine of claim 7, wherein the heating box defines a second output opening surrounded by the top panel, the first side panel, and the second side panel; and the second output opening is configured to allow the one of the plurality of products to drop out of the heating box to the receiving area.

9. The vending machine of claim 8, wherein the heating box comprises a second shade mounted between the first side panel and the second side panel to cover the second output opening.

10. A vending machine comprising:
a cabinet, the cabinet defines a storing area for storing a plurality of products, a receiving area; and
an output delivering device mounted to the cabinet, the output delivering device comprises a mounting panel and a heating box placed on the mounting panel; the heating box defines an input opening and a first output opening; the heating box is configured to receive one of the plurality of products which is pushed along a first direction via the input opening and heat the one of the plurality of products;
wherein he heating box is driven to move along a second direction, substantially perpendicular to the first direction, to a position in which the product drops out of the heating box via the first output opening to the receiving area .

11. The vending machine of claim 10, wherein the output delivering device further comprises a motor, a slave gear, and a delivering strap; the motor and the slave gear mounted on the mounting panel; the motor comprises a drive gear; the delivering strap is connected to the slave gear and the drive gear; the motor is configured to drive the delivering strap to rotate, thereby driving the heating box to move relative to the mounting panel.

12. The vending machine of claim 11, wherein the output delivering device further comprises a mounting member; the mounting member is mounted to the delivering strap and the heating box; and the delivering strap and the heating box are located on opposite sides of the mounting panel.

13. The vending machine of claim 12, wherein the heating box defines two first securing holes; the mounting member comprises two securing arms; each of the two securing arms defines a second securing hole corresponding to the first securing hole.

14. The vending machine of claim 10, wherein the heating box comprises a top panel, a first side panel extending from the top panel, a second side panel extending from the top panel, and a rear panel connected between the first side panel and the second side panel; the input opening is defined in the first side panel; and the first output opening is surrounded by the first side panel, the second side panel, and the rear panel.

15. The vending machine of claim 14, wherein the heating box comprises a soft shade mounted to the top panel and covering the input opening.

16. The vending machine of claim 15, wherein the heating box defines a second output opening surrounded by the top panel, the first side panel, and the second side panel; and the second output opening is configured to allow the one of the plurality of products to drop out of the heating box to the receiving area.

17. The vending machine of claim 16, wherein the heating box comprises a second shade mounted between the first side panel and the second side panel to cover the second output opening.

18. The vending machine of claim 10, wherein the cabinet defines a pickup opening communicating with the receiving area, and the pickup opening is configured to allow the one of the plurality of products in the receiving area to be picked up.
